(19) United States
(12) Patent Application Publication
(10) Pub. No.: US 2012/0231186 A1
(43) Pub. Date: Sep. 13, 2012

(54) ROTATIONAL CASTING PROCESS

(75) Inventors: Gary T. Burns, Sunset, SC (US); Robert J. Harmer, Midland, MI (US)

(73) Assignee: Dow Corning Corporation, Midland, MI (US)

(21) Appl. No.: 13/511,344

(22) PCT Filed: Nov. 24, 2010
(86) PCT No.: PCT/US10/58068

§ 371 Date: May 22, 2012

Related U.S. Application Data
(60) Provisional application No. 61/265,624, filed on Dec. 1, 2009.

(51) Int. Cl. C01B 33/037; B32B 1/00

(52) U.S. Cl. 428/34.1; 65/71

(57) ABSTRACT

In various embodiments, provided are methods of refining silicon wherein impurities of different densities are separated and concentrated using centrifugal force, and controlled crystallization of molten silicon provides further purification through concentration of impurities at a solid/liquid interface.

The present application relates to methods of refining silicon using a rotational casting process, wherein in some embodiments, impurities of different densities are separated and concentrated using centrifugal force, controlled crystallization of the silicon, or combination thereof.

Metallurgical-grade silicon (typically having purity of 98-99%) is produced by reducing silica with aluminum or a carbonaceous material (for example, coal or coke) to yield a product that unavoidably contains carbon, boron, phosphorus, metals, and other impurities. While metallurgical-grade silicon is suitable for some applications (for example, as an alloying material in the metals industry), it is not pure enough for solar cells, semi-conductors, thin films, liquid crystal displays, or other applications requiring high purity silicon (i.e., silicon having purity of 99.999% or higher).

In order to meet the demand for higher purity silicon, various methods of purifying silicon, as well as combinations of methods, have been employed. In a typical combination of processes, metallurgical grade silicon is chemically converted to a monomeric silane. The silane is then converted to higher purity silicon (typically by Siemens or fluidized bed processes), wherein the higher purity silicon is melted and used to grow crystals. In an alternative combination of processes, metallurgical grade silicon may be refined through several intermediate furnace and ladle processing steps prior to a final purification using one or more directional solidifications of a silicon melt.

There are a variety of methods of growing crystals of silicon from a melt, including the Czochralski (CZ) technique, heat exchanger method (HEM), shaped ribbon method (EFG), and the dendritic web method (WEB). In such methods, directional growth of crystals occurs, while impurities tend to concentrate at the solid/liquid interface of the solidifying silicon. With the partial exception of HEM, these directional solidification processes are complex, require high purity silicon feedstock, have high production costs, and are generally unsuitable for high throughput purification.

While the HEM process can be used for growing crystals from high purity silicon, it is also used for the bulk purification of silicon. The process involves loading silicon into a square fixed crucible that is placed in a constant temperature hot zone, the directional flow of heat from the hot ingot to the exterior being assumed by a gas cooled heat exchanger base-plate on which the crucible is placed. Crystal growth occurs from the bottom of the crucible to the top, with a planar solid/liquid interface at which impurities tend to concentrate. During solidification, ambient conditions are controlled to yield low oxygen and carbon concentrations. After solidification is completed, the ingot is annealed in situ to reduce residual stress and produce uniform properties. By this process, a 200-800 kg ingot of purified silicon can be produced within a 50-60 hour cycle time. Disadvantages of the HEM process include its long cycle time, considerable energy requirements, and inefficiency for high throughput purification of silicon.

Therefore, there remains a need in the art for efficient, cost-effective, high throughput methods for the bulk purification of silicon.

These needs are met by the present application, which provides in various embodiments, methods of refining silicon. In some embodiments, a method of refining silicon comprises (I) providing a mold comprising a longitudinal axis, a mold cavity defined by an inner mold surface and a hollow bore extending along the longitudinal axis, and an outer mold surface; (II) pre-heating the mold cavity; (III) introducing a predetermined amount of molten silicon into the heated mold cavity while continuously rotating the mold around the longitudinal axis at a speed sufficient to form a hollow body of molten silicon comprising an inner surface and an outer surface that is in contact with the inner mold surface, wherein the body extends along the longitudinal axis of the mold; and (IV) cooling the outer mold surface while continuously rotating the mold to effect directional solidification of the molten silicon from the outer surface of the body to the inner surface of the body.

According to various embodiments, impurities of different densities are separated and concentrated using centrifugal force and/or controlled crystallization of the silicon to provide purification through concentration of impurities. In various embodiments, suitable heating devices may be utilized to remove volatile impurities and/or control the rate of crystallization of silicon. According to various embodiments, the methods described herein are suitable for the purification of any grade of silicon, including but not limited to, chemical grade, metallurgical grade, electronics grade, and solar grade silicon, as well as silicon-containing alloys.

A more complete appreciation of the invention and the many embodiments thereof will be readily obtained as the same becomes better understood by reference to the following detailed description when considered in connection with the accompanying drawings, wherein:

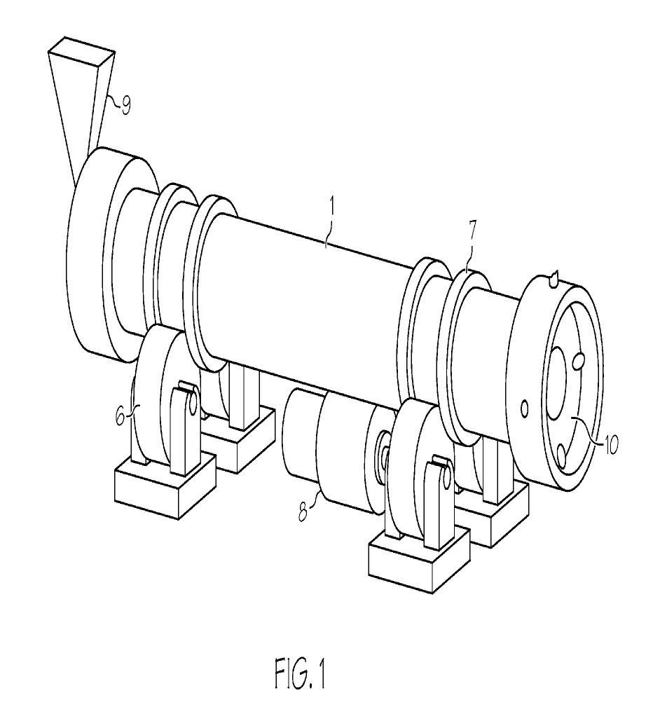

FIG. 1 illustrates a horizontal centrifugal casting apparatus;

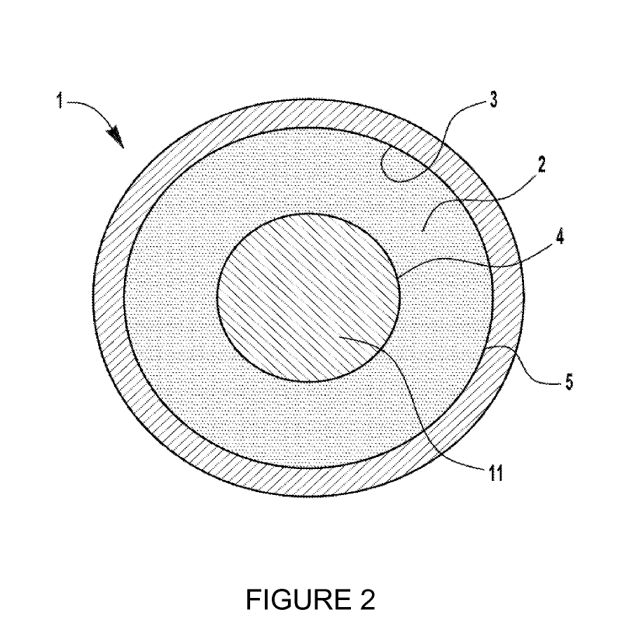

FIG. 2 illustrates a cross-section of a mold comprising a silicon body, wherein the cross-section is in a plane perpendicular to the longitudinal axis of the mold;

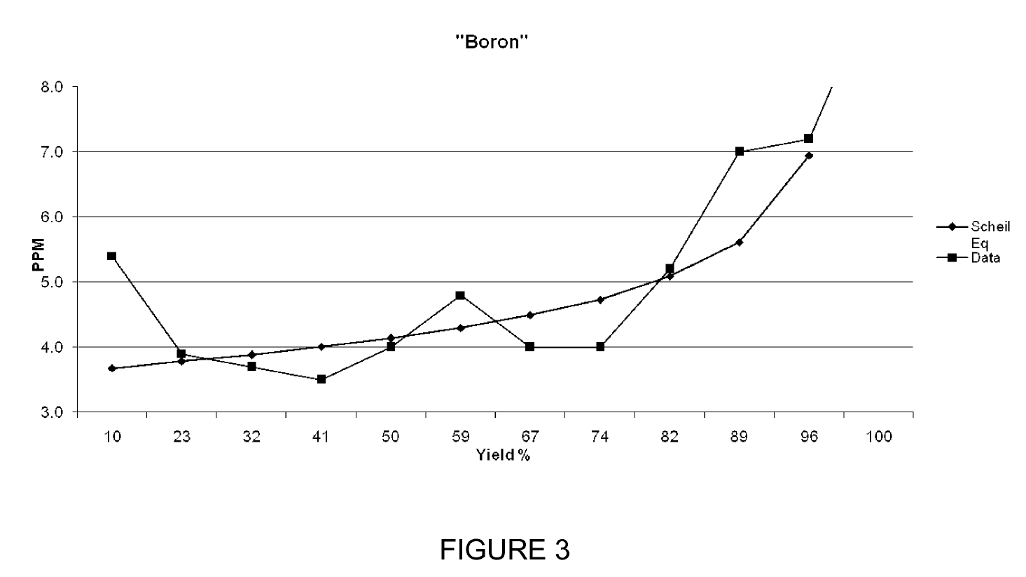

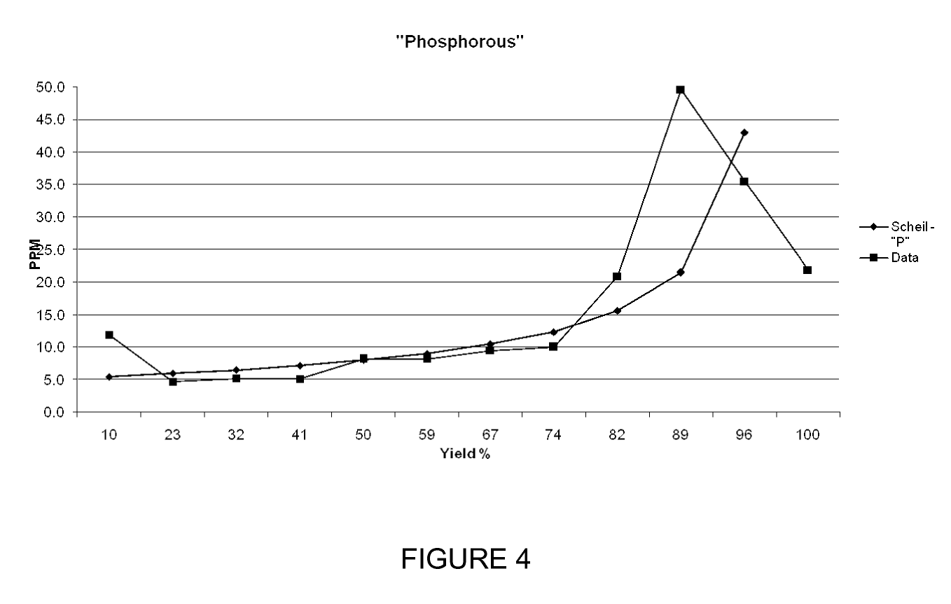

FIGS. 3-4 illustrate the boron and phosphorus content in slice samples from Example 1 as a function of crystallization depth and compare such data with theoretical expectations;

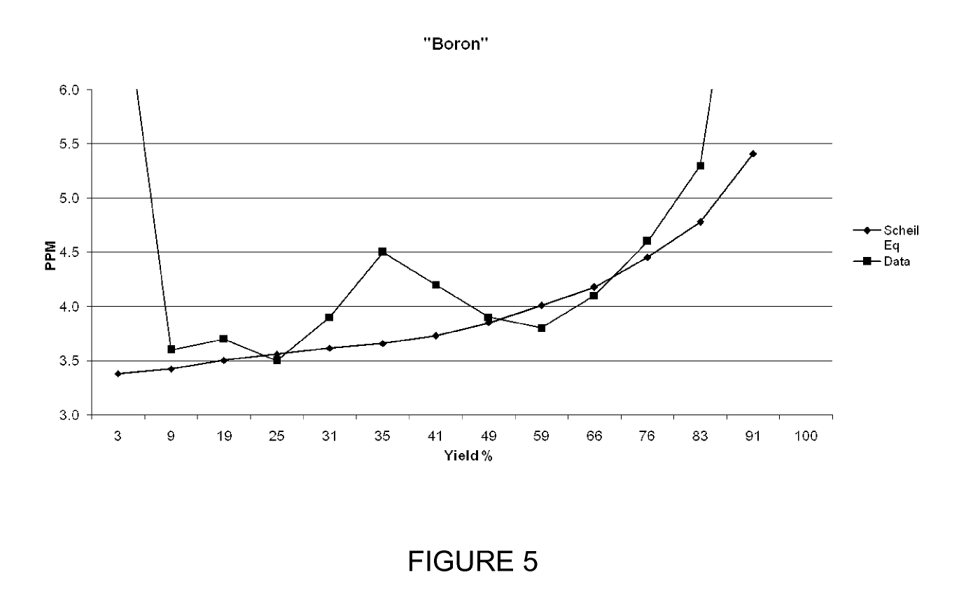

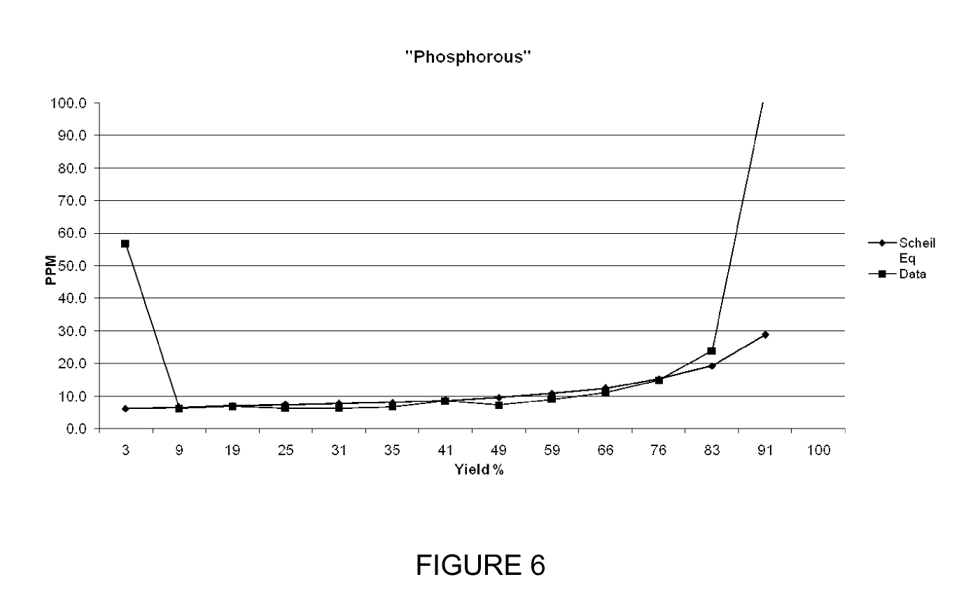

FIGS. 5-6 illustrate the boron and phosphorus content in slice samples from Example 2 as a function of crystallization depth and compare such data with theoretical expectations;

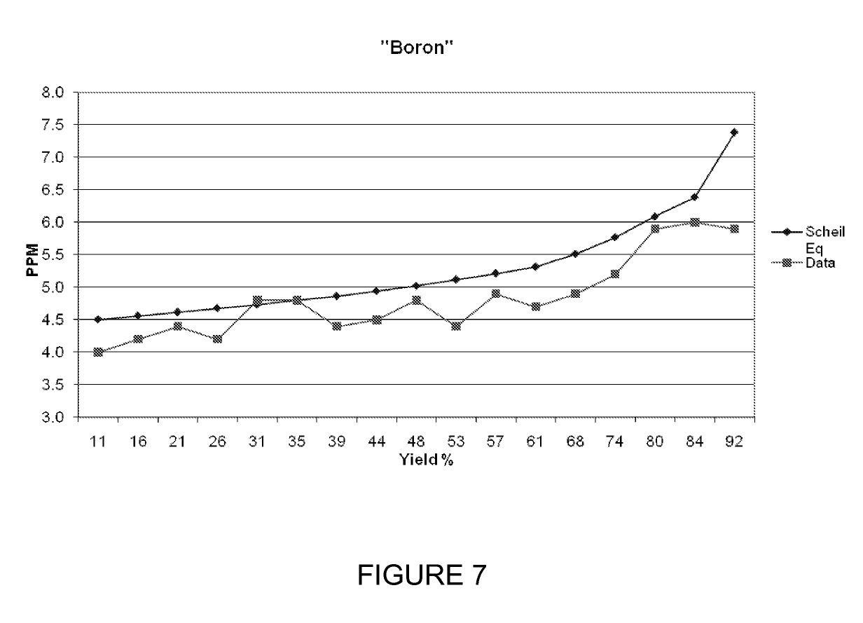

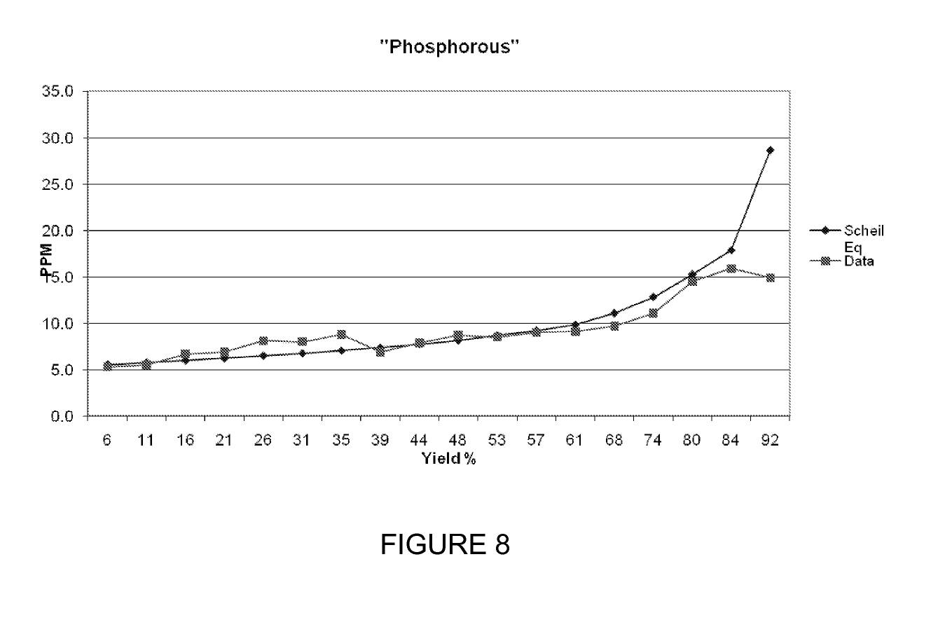

FIGS. 7-8 illustrate the boron and phosphorus content in slice samples from Example 5 as a function of crystallization depth and compare such data with theoretical expectations; and

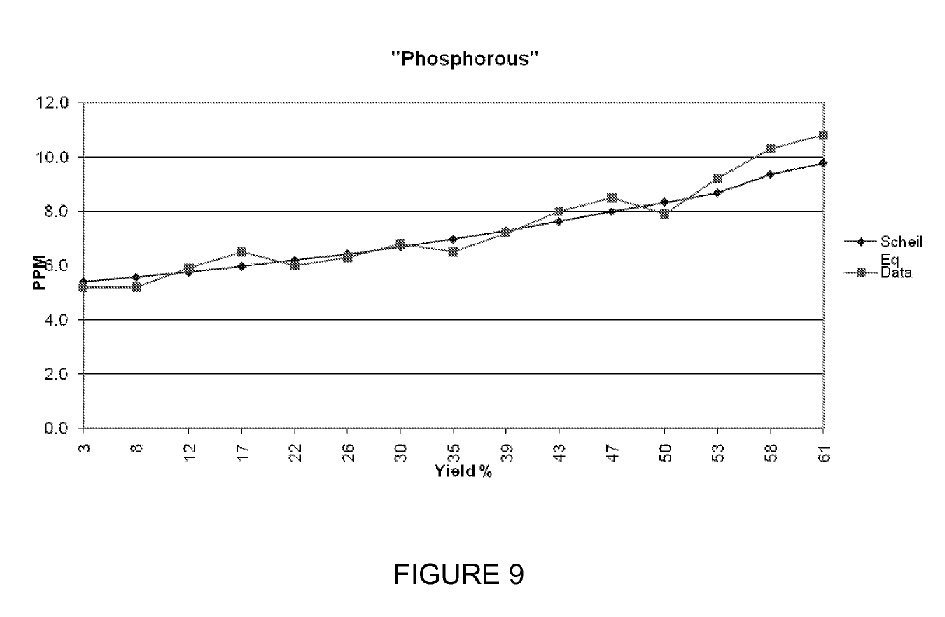

FIG. 9 illustrates the phosphorus content in slice samples from Example 6 as a function of crystallization depth and compares such data with theoretical expectations.

These and additional features and advantages of the invention will become apparent in the course of the following detailed description.

Specific embodiments of the present invention will now be described. The invention may, however, be embodied in different forms and should not be construed as limited to the embodiments set forth herein. Rather, these embodiments are provided so that this disclosure will be thorough and complete and will fully convey the scope of the invention to those skilled in the art.

Unless otherwise defined, all technical and scientific terms used herein have the same meaning as commonly understood by one of ordinary skill in the art to which the invention pertains. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

As used in the specification and appended claims, the term “substantially vertical” is intended to mean vertical with respect to the earth's surface, as well as from ±0 to 45° from vertical, and the term “substantially horizontal” is intended to mean horizontal with respect to the earth's surface, as well as from ±0 to 45° from horizontal.

As used in the specification and appended claims, the term “longitudinal axis” is intended to refer to an imaginary reference axis running lengthwise (i.e., from the first end to the second end) through the center of an object.

As used in the specification and appended claims, the term “raining” is intended to refer to the effect that occurs when the rotational speed of molten metal within a spinning mold is less than that required to generate sufficient centrifugal force to overcome the effects of gravitational forces. This condition will cause molten metal to fall from the hypothetical “top” of the spinning mold into the body of molten metal concentrated at the hypothetical “bottom” of the spinning mold. Raining can be promoted by controlling temperature or fluidity of the molten metal and/or by controlling the rotational speed of the mold for a given mold diameter.

As used in the specification and appended claims, the term “slippage” is intended to refer to the effect that occurs when the rotational speed of molten metal within a spinning mold is greater than or less than the rotational speed of the mold itself. Slippage can be promoted through rapid acceleration and/or deceleration of the mold.

As used in the specification and appended claims, the unit “G” is intended to refer to and represents the number of times of equivalent gravitational acceleration created on the inner diameter of a rotating body (i.e., casting and/or mold). Mass and inner diameter of the rotating body are determined by mold/casting dimensions, thereby making rotational speed (expressible as either linear or angular speed) of the body the variable for the action of centrifugal force. Accordingly, the use of equivalent gravitational acceleration (or “G”) allows for simplification of the possible combinations of variable masses and diameters, and allows for a unified means for expressing and comparing rotational speed. For example, when referring to a rotating mass having an equivalent gravitational acceleration of 1 G, such reference incorporates the forces on a mass having a diameter of 3 inches being spun at 154 revolutions/minute (RPM), as well as the same mass having a diameter of 6 inches being spun at 110 RPM, since the centrifugal force acting on the mass is the same. Other non-limiting examples may be ascertained by reference to FIG. 8-1 of Centrifugal Casting by Nathan Janco, American Foundry Society (1988).

Unless otherwise indicated, all numbers expressing quantities of ingredients, properties such as molecular weight, reaction conditions, and so forth as used in the specification and claims are to be understood as being modified in all instances by the term “about.” Additionally, the disclosure of any ranges in the specification and claims are to be understood as including the range itself and also anything subsumed therein, as well as endpoints. Unless otherwise indicated, the numerical properties set forth in the specification and claims are approximations that may vary depending on the desired properties sought to be obtained in embodiments of the present invention. Notwithstanding that numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

In various embodiments, provided herein are methods of refining silicon and silicon alloys (referred to collectively herein as “silicon”), as well as silicon refined by such methods. According to various embodiments, a method of refining silicon comprises (I) providing a mold comprising a longitudinal axis, a mold cavity defined by an inner mold surface and a hollow bore extending along the longitudinal axis, and an outer mold surface; (II) pre-heating the mold; (III) introducing a predetermined amount of molten silicon into the heated mold cavity while continuously rotating the mold around the longitudinal axis at a speed sufficient to form a hollow body of molten silicon comprising an inner surface and an outer surface that is in contact with the inner mold surface, wherein the body extends along the longitudinal axis of the mold; and (IV) cooling the outer mold surface while continuously rotating the mold to effect directional solidification of the molten silicon from the outer surface of the body to the inner surface of the body. In some embodiments, the inner silicon surface may be heated to control the rate of directional solidification from the outer surface of the body to the inner surface of the body.

The method provided herein comprises (I) providing a mold comprising a longitudinal axis, a mold cavity defined by an inner mold surface and a hollow bore extending along the longitudinal axis, and an outer mold surface. Mold cavity dimensions and the volume of molten silicon introduced can be configured to provide castings of varied size, weight, diameter, and wall thickness. In some embodiments, the mold may be of varied shapes or diameters, provided that the diameter of the mold cavity is uniform and concentric to the diameter of the outer mold surface. In some embodiments, the mold has a shape selected from cylindrical and tapered. In some embodiments, the mold may be of a material suitable for high temperature applications. Examples of suitable materials include, but are not limited to, steel, cast iron, steel alloys, molybdenum, titanium, ceramic and other materials suited to the operating temperature and stresses of the process. Materials may be solid or composite layered to form the mold body. In some embodiments, the mold may be maintained at an orientation that is substantially vertical or substantially horizontal. In some embodiments, one or more end-caps may be utilized with the mold to prevent leakage of the molten silicon. Good results have been obtained with a cylindrical steel mold maintained at a substantially horizontal orientation. In some embodiments, a suitable mold is one that is capable of obtaining and maintaining a rotational speed that will generate centrifugal acceleration of up to 400 G on its inner surface and the molten silicon within its cavity. According to various embodiments, the inner mold surface comprises a high temperature, non-reactive refractory material suitable for providing a mold release and thermal interface for the silicon introduced into the mold. Examples of suitable materials include, but are not limited to, silica, silicon carbide, silicon nitride, boron nitride, alumina, magnesia, alumina-silicate, and combinations thereof. In some embodiments, the refractory material comprises at least 1% (w/w) of silica. In some embodiments, the refractory material comprises from about 10 to about 100% (w/w) of silica. For example, the refractory material may comprise from about 10-15%, 15-20%, 20-25%, 25-30%, 30-35%, 35-40%, 40-45%, 45-50%, 50-55%, 55-60%, 60-65%, 65-70%, 70-75%, 75-80%, 80-85%, 85-90%, 90-95%, 95-100% (w/w) of silica. Good results have been obtained with a refractory material comprising from about 30 to about 98% (w/w) of silica. The refractory material is uniformly applied to the inside surface of the mold and may be applied in any suitable manner including, but not limited to, spray coating or hand loading into the spinning mold.

The method provided herein comprises (II) heating the mold prior to introducing a predetermined amount of molten silicon. In some embodiments, the outer mold surface is heated to a temperature of from about 25 to about 700° C. For example, the temperature may be 25-50° C., 50-100° C., 100-150° C., 150-200° C., 200-250° C., 250-300° C., 300-350° C., 350-400° C., 400-450° C., 450-500° C., 500-550° C., 550-600° C., 600-650° C., 650-700° C., or combinations thereof. In some embodiments, the inner mold surface is heated to a temperature of from about 25 to about 1600° C. For example, the temperature may be 25-50° C., 50-100° C., 100-150° C., 150-200° C., 200-250° C., 250-300° C., 300-350° C., 350-400° C., 400-450° C., 450-500° C., 500-550° C., 550-600° C., 600-650° C., 650-700° C., 700-750° C., 750-800° C., 800-850° C., 850-900° C., 900-950° C., 950-1000° C., 1000-1050° C., 1050-1100° C., 1100-1150° C., 1150-1200° C., 1200-1250° C., 1250-1300° C., 1300-1350° C., 1350-1400° C., 1400-1450° C., 1450-1500° C., 1500-1550° C., 1550-1600° C., or combinations thereof. In some embodiments, the inner mold surface is heated to a temperature that is above the melting temperature of the silicon to be introduced into the mold. In some embodiments, the outer mold surface and the inner mold surfaces are heated. The mold may be heated by any suitable heating device, and the devices used for heating the inner and outer mold surfaces may be the same or different. Examples of suitable heating devices include, but are not limited to, a hydrogen/oxygen torch, an oven, a fuel gas heater/burner, an electric heater, or combinations thereof. Good results have been obtained with heating the outer mold surface to a temperature of from about 25° C. to about 350° C. and the inner mold surface to a temperature of from about 1100° C. to about 1550° C.

The method provided herein comprises (III) introducing a predetermined amount of molten silicon into the heated mold while continuously rotating the mold around the longitudinal axis at a speed sufficient to form a hollow body of molten silicon comprising an inner surface and an outer surface that is in contact with the inner mold surface, wherein the body extends along the longitudinal axis of the mold. If the rotational speed of the mold and the fluidity/temperature of the molten silicon are adequate, the molten silicon is uniformly distributed along the inner mold surface throughout the length of the mold. According to some embodiments, rotation of the mold around the longitudinal axis at a speed sufficient to generate equivalent gravitational acceleration of from about 1 to about 400 G is sufficient to form the body of molten silicon. For example, rotational speed may be sufficient to generate 1-15 G, 15-30 G, 30-45 G, 45-60 G, 60-75 G, 75-90 G, 90-105 G, 105-120 G, 120-135 G, 135-150 G, 150-165 G, 165-180 G, 180-195 G, 195-210 G, 210-225 G, 225-240 G, 240-255 G, 255-270 G, 270-285 G, 285-300 G, 300-315 G, 315-330 G, 330-345 G, 345-360 G, 360-375 G, 375-390 G, 390-400 G, and combinations thereof. Good results have been obtained with rotational speeds sufficient to generate from about 3 to about 120 G. In some embodiments, the rotational speed can be lower during introduction of the molten silicon followed by rapid acceleration. In alternative embodiments, the molten silicon can be introduced into a stationary mold, followed by rapid acceleration to cause uniform distribution. It should be apparent to one skilled in the art that suitable equivalent gravitational acceleration (G) varies with respect to mold size, mold cavity size, desired casting size, volume of silicon feedstock introduced, desired purity, and other application-specific factors. Thus, one skilled in the art will understand that the present invention is not limited to the rotational speeds or equivalent gravitational acceleration described herein.

The molten silicon may be introduced into the mold in any suitable manner, but is typically introduced in a manner allowing its initial speed to be in the direction of the molds rotation in order to provide a uniform distribution on the inner mold surface. Examples of suitable pouring devices include, but are not limited to, a ladle, an angled nozzle spout, a straight nozzle spout, or a pouring boot. In some embodiments, the molten silicon can be introduced at one end of the mold, from both ends of the mold, from the interior of the mold (via use of a lance or other distributor), or combinations thereof. In some embodiments, the molten silicon can be filtered for impurities prior to, or concurrent with, its introduction into the mold, and any suitable filter may be utilized. Examples of suitable filters include, but are not limited to, silicon carbide, aluminum oxide, and aluminum oxide/graphite ceramic filters. Good results have been obtained with pre-filtering the molten silicon by pouring through a silicon carbide ceramic foam filter. In some embodiments, the molten silicon can be introduced and maintained within the spinning mold while under a vacuum or inert ambient conditions.

According to various embodiments, after introduction of the molten silicon, the method comprises continuing rotation of the heated mold at a sufficient temperature and duration to provide sufficient time for particle and slag migration through the melt into the outer surface of the silicon body. Higher density “sinking” slag and other impurities will be concentrated on the outer surface of the silicon body closest to the refractory layer and lighter density “floating” slag and other impurities will concentrate at the inner surface of the silicon body. The use of a synthetic slag can also be employed to assist in the migration and concentration of impurities within the silicon body, and/or to assist in the provision of a thermal barrier as a means to control heat loss from the inner surface of the liquid silicon body. Such slag can be introduced into the molten silicon during the pouring process into the mold. In some embodiments, the mold cavity/hollow silicon body may be heated during this process in order to maintain a temperature of from about 1100 to 1600° C. For example, temperature may be maintained at 1100-1150° C., 1150-1200° C., 1200-1250° C., 1250-1300° C., 1300-1350° C., 1350-1400° C., 1400-1450° C., 1450-1500° C., 1500-1550° C., 1550-1600° C., and combinations thereof. In some embodiments, the outer mold surface may be heated during this process in order to maintain a temperature of from about 25 to 700° C. For example, temperature may be maintained at 25-50° C., 50-100° C., 100-150° C., 150-200° C., 200-250° C., 250-300° C., 300-350° C., 350-400° C., 400-450° C., 450-500° C., 500-550° C., 550-600° C., 600-650° C., 650-700° C., and combinations thereof.

Mold and silicon body temperature may be controlled by any suitable device. Examples of suitable devices include, but are not limited to, a hydrogen/oxygen torch, an oven, a fuel gas heater/burner/torch, an electric heater, a water box, a water spray, a water jet, compressed air and other gases, and combinations thereof. Good results have been obtained by use of an external fuel gas burner to heat the outer mold surface, or a water spray jet to cool the outer mold surface, or a propane/oxygen torch to heat the inner mold surface/hollow silicon body.

In some embodiments, a hydrogen/oxygen torch may also be used to refine silicon. The torch is directly combusted within the mold cavity/hollow silicon body, wherein the resultant combustion gas introduces water vapor, and/or unreacted hydrogen or oxygen into the molten silicon to promote refining of the silicon through oxidation and vaporization of the entrained impurities. Targeted impurities for removal include, but are not limited to, sodium, calcium, potassium, boron, and phosphorus. The refining of molten silicon with a hydrogen/oxygen torch may also be, but is not required to be, practiced in combination with controlling the speed of the rotating mold to cause slippage or raining of the molten silicon in order to achieve mixing, which increases the surface area of the molten silicon exposed to the torch combustion gases, thereby allowing for removal of volatile impurities.

In some embodiments, the speed of the mold is decreased after the heated mold has been rotated at a sufficient temperature and duration to cause one or more higher density impurities in the molten silicon to concentrate near the outer surface of the body and one or more lower density impurities to concentrate near the inner surface of the body. For example, after the silicon body has been formed, the mold may be rotated at a temperature and duration sufficient to cause at least silicon carbide to concentrate near the outer surface of the body. In some embodiments, the speed may be decreased to speeds sufficient to generate equivalent gravitational acceleration of from about 1 to about 25 G. For example, reduced speed may be sufficient to generate 1-5 G, 5-10 G, 10-15 G, 15-20 G, 20-25 G, and combinations thereof. Good results have been obtained by decreasing the speed of the mold to speeds sufficient to generate from about 3 to about 10 G.

The method provided herein comprises (IV) cooling the outer mold surface while continuously rotating the mold to effect directional solidification of the molten silicon from the outer surface of the body to the inner surface of the body. By cooling the outer mold surface (and controlling the temperature of the inner surface of the silicon body), controlled silicon crystal growth (in a radial direction from the silicon/refractory interface towards the inner surface of the silicon body) can be achieved. In some embodiments, such directional solidification occurs at a rate of from about 0.1 to about 3 millimeters/minute. In some embodiments, such directional solidification occurs at a rate of from about 0.5 to about 1.5 millimeters/minute. However, one of skill in the art will realize that other rates of solidification are possible and that the present invention is not limited to the rates of solidification described herein. One of skill in the art will also realize that any suitable cooling device may be used to cool the outer surface of the mold, thereby controlling the rate of directional solidification. Examples of suitable cooling devices include, but are not limited to, a water box, a water spray, compressed air and other gases, liquefied gases, and a water jet.

It is well understood by those versed in the art of silicon directional solidification, that maximization of the segregation velocity during directional solidification can be achieved through the mixing of the liquid silicon at the liquid/solid interface. According to embodiments of the instant method, this mixing effect can be achieved through slippage of the liquid silicon by the controlled rapid acceleration and deceleration of the spinning mold (via controlling drive motor speed control through variable frequency drive technology); by rotating the mold at or near raining speed; through recirculation currents generated within the rotating mold cavity; and combinations thereof.

According to various embodiments, the method comprises varying the speed of the mold to that sufficient to cause slippage or raining of the molten silicon to achieve mixing of the liquid silicon at the liquid/solid interface. While, the step of raining is typically performed prior to directional solidification, it may also be done after the onset of directional solidification. According to various embodiments, the method comprises rapidly varying the speed of the mold in order to cause slippage of the molten silicon, thereby achieving mixing of the liquid silicon at the liquid/solid interface. In some embodiments, the rotation of the mold is rapidly decreased to speeds sufficient to generate equivalent gravitational acceleration of from about 3 G to about 25 G. For example, rotational speed may be decreased to speeds sufficient to generate equivalent gravitational acceleration of from about 3 G-5 G, 5 G-10 G, 10 G-15 G, 15 G-20 G, 20 G-25 G, or combinations thereof. In some embodiments, the rotational speed of the mold may be rapidly increased to speeds sufficient to generate equivalent gravitational acceleration of from about 140 G to about 300 G. For example, rotational speed may be increased to speeds sufficient to generate equivalent gravitational acceleration of from about 140 G -160 G, 160 G-180 G, 180 G-200 G, 200 G-220 G, 220 G-240 G, 240 G-260 G, 260 G-280 G, 280 G -300 G, or combinations thereof. Good results have been obtained by rapidly decreasing the rotational speed of the mold to speeds sufficient to generate equivalent gravitational acceleration of from about 3 G to about 10 G, followed by rapidly increasing the rotational speed of the mold to speeds sufficient to generate equivalent gravitational acceleration of from about 150 G to about 200 G.

According to various embodiments, the method comprises the use of recirculation flows within the spinning mold to achieve mixing of the liquid silicon at the liquid/solid interface. Recirculation flow is generated within the molten silicon, which disperses the saturated impurity boundary during the directional solidification process. In some embodiments, mold vibration is generated through imbalance of the spinning mass to promote this effect.

According to various embodiments, after a desired yield of solidified silicon is achieved, the rotational speed of the mold may be decreased, the mold elevated, and the remaining liquid silicon poured from the end of the mold, thereby leaving a hollow solidified silicon casting within the mold.

According to various embodiments, after a desired yield of solidified silicon is achieved, the mold rotation can be stopped, the mold end-cap(s) opened, and the remaining liquid silicon poured from the end of the mold, thereby leaving a hollow solidified silicon casting within the mold.

The hollow silicon casting comprises an inner surface and an outer surface that is in contact with the inner mold surface. The molten silicon removed has a higher concentration of impurities as compared to the remaining solidified silicon in the casting and can be used as a secondary product or be recycled for other purposes. In some embodiments, the rotational speed of the mold may be decreased and the remaining molten silicon removed when from about 10 to about 90% (w/w) of the molten silicon has solidified. For example, the molten silicon can be removed when solidification is 10-20%, 20-30%, 30-40%, 40-50%, 50-60%, 60-70%, 70-80%, 80-90%, and combinations thereof. Good results have been obtained by decreasing the speed of from about 0 to about 3 G and removing the remaining molten silicon when from about 50 to about 80% (w/w) of the molten silicon has solidified.

According to various embodiments, after the molten silicon is removed, a heating device (such as a hydrogen/oxygen torch) can be used to melt a thin layer of silicon from the hollow casting to release concentrated impurities trapped within the dendritic structure of the crystallized silicon. The resulting molten silicon is also removed. Good results have been obtained by melting a 1-5 mm layer of silicon from the hollow casting. However, one of skill in the will understand that the desired depth of melting will depend upon the specific application and that the present invention is not limited to the depths described herein.

According to various embodiments, after a desired percentage of the molten silicon has solidified and the remaining molten silicon has been removed, the method comprises cooling the mold and casting to a sufficient temperature (for example, 150-250° C.), and separating the silicon casting from the mold. The casting can be extracted from the centrifugal mold via a machine mounted hydraulic extraction mechanism. In some embodiments, the mold cavity may be tapered (for example, 2-5 degrees) to facilitate easier removal of the casting from the refractory interface. Additionally, supplemental heat from only the external heating device can also be applied to the external surface of the mold to facilitate an expansion of the outer mold surface relative to the casting outer surface.

In some embodiments, residual higher density impurities from the outer surface of the silicon casting and residual lower density impurities from the inner surface of the silicon casting can be removed by surface treatment. Treatment of the inner and outer surfaces of the casting in order to remove additional impurities may be achieved by any suitable process. Examples include, but are not limited to, melting or chipping, sawing, vaporizing, particle blasting, or use of other ablative processes to remove a predetermined amount of the surface where undesired impurities are concentrated. Good results have been obtained by removing the impurities on the outer and inner surfaces of the casting by chipping and quartz grit blasting. After the casting has been cooled, removed from the mold, and further refined by surface treatment, it may be crushed and packaged per suitable material handling processes.

The method provided herein allows for efficient, cost-effective, high throughput methods for the bulk purification of silicon. For example, the provided method may be used to reduce the concentration of one or more of sodium, calcium, potassium, boron, phosphorus, and silicon carbide in silicon. The method can be used with any grade of silicon feedstock, including but not limited to, chemical grade, metallurgical grade, electronics grade, and solar grade silicon, as well as silicon-containing alloys. The purified silicon prepared according to the methods provided herein may be used in a variety of applications with or without further refinement. However, one of skill in the art will recognize that the degree of refinement achievable within one casting is dependent upon, among other things, the grade of silicon feedstock. Accordingly, the methods described herein may need to be repeated more than once in order to achieve the desired purity of refined silicon.

In some embodiments, the unrefined molten silicon introduced into the mold has an overall purity of from about 99 to about 99.999%. In some embodiments, the molten silicon introduced into the mold comprises from about 0.1 to about 20 ppm boron. In some embodiments, the molten silicon introduced into the mold comprises from about 0.2 to about 60 ppm phosphorus. In some embodiments, the molten silicon introduced into the mold comprises from about 0.4 to about 5 ppm boron and from about 1 to about 20 ppm phosphorus.

In some embodiments, the refined silicon prepared by the methods provided herein has an overall purity of from about 99.9 to about 99.99999%. In some embodiments, the refined silicon comprises from about 0.08 to about 18 ppm boron. In some embodiments, the refined silicon comprises less than 1.0 ppm boron. In some embodiments, the refined silicon comprises less than 0.3 ppm boron. In some embodiments, the refined silicon comprises from about 0.2 to about 30 ppm phosphorus. In some embodiments, the refined silicon comprises less than 1.0 ppm phosphorus. In some embodiments, the refined silicon comprises less than 0.5 ppm phosphorus. In some embodiments, the refined silicon comprises less than 1.0 ppm boron and less than 1 ppm phosphorus. In some embodiments, the refined silicon comprises less than 0.3 ppm boron and less than 0.5 ppm phosphorus. One skilled in the art will recognize that the degree of purification of the silicon will depend upon, among other things, the grade of silicon feedstock and the embodiments of the provided methods that are practiced.

In practice of embodiments of the provided method, a centrifugal casting apparatus is utilized. As illustrated in FIGS. 1-2, such an apparatus comprises a mold 1 that is rotated at speeds which generate sufficient centrifugal force to evenly distribute molten silicon 2 against the inner surface 3 of the mold 1. In some embodiments, the mold 1 has been coated with refractory (not shown). Through the use of centrifugal force, impurities of various densities are concentrated at the inner 4 and outer 5 surfaces of the solidified silicon 2. Through controlled heat extraction, the molten silicon 2 is directionally solidified and further refined through concentration of impurities. In some embodiments, a hydrogen/oxygen torch (not shown) is directly combusted within the mold cavity/hollow silicon body in order to remove impurities from the molten silicon 2.

In some embodiments, the mold may be removable from the casting apparatus and interchangeable with other molds to produce castings of various shapes, diameters, and lengths. Typically, the mold is rotated on mechanical drive rollers 6, roller tracks 7, and/or carrying rollers (not shown), and control of rotation speed is achieved by use of a variable speed drive motor 8 operably coupled to the mold 1. Fixed speed, acceleration and deceleration rates can also be programmed into a variable speed drive control in order to meet the requirements of various embodiments of the method. The casting apparatus is typically floor mounted and consists of a heavy duty carrying frame that supports the main drive mechanism and auxiliary equipment used to apply refractory materials and perform casting extraction. It should be apparent to one of skill in the art that other components and configurations of components could be used and that the present invention is not limited to the disclosed components and/or configuration of the casting apparatus.

In practice of embodiments of the provided method, molten silicon is typically poured from foundry transport ladles (not shown) into the casting apparatus through an integrated funnel 9 and distribution lance (not shown). As the molten silicon 2 contacts the spinning inner surface of the mold 1, it accelerates to the same speed of the mold 1 and through centrifugal force, is uniformly distributed over the mold inner surface 3. Typically, removable mold end plates 10 are employed to contain the molten silicon 2 within the mold cavity 11. Through controlled thermal management of the process, the molten silicon 2 within the mold 1 is cooled and directionally solidified from the inner mold surface 3 towards the inner surface 4 of the casting.

The described embodiments will be better understood by reference to the following examples which are offered by way of illustration and which one of skill in the art will recognize are not meant to be limiting.

### Example 1

Approximately 121 kg of silicon metal was melted in a 1000 lb “Box” InductoTherm induction furnace lined with an Engineered Ceramics “Hycor” model CP-2457 crucible and sealed with Vesuvius “Cercast 3000” top cap refractory. During the melting process, a nitrogen gas purge was introduced into the induction furnace headspace to reduce the formation of SiO gas and silicon dioxide.

The silicon melt was heated to 1524° C., prior to being poured into a Cercast 3000 refractory lined, transfer ladle. The transfer ladle was preheated to 800° C., using a propane/air fuel torch assembly. After pouring, the temperature of the silicon melt in the transfer ladle was measured at 1520° C. prior to pouring into the centrifugal casting machine. The silicon was sampled from both the furnace and transfer ladle to establish a baseline material elemental analysis.

A model M-24-22-12-WC centrifugal casting machine manufactured by the “Centrifugal Casting Machine Company” was fitted with a refractory lined, nominal 420 mm diameter×635 mm long steel casting mold. The silicon casting produced in this experiment measured 372 mm in diameter×635 mm long×74 mm wall thickness. Advantage W5010 mold wash was sprayed onto the inner surface of the rotating casting mold to provide a base coating of approximately 1 mm thick. The steel mold was rotated at 58 rpm and was preheated to 175° C. using an external burner assembly. The mold was then sped up to 735 rpm and hand-loaded with a sufficient volume of Cercast 3000 refractory to centrifugally create a 19 mm thick refractory layer within the mold. The mold was then transferred into a heat treatment oven whereby the mold was maintained at 175° C. for an additional 4 hrs before being allowed to slowly cool to ambient temperature.

Vesuvius “Surebond SDM 35” was hand loaded into the mold cavity and the mold was spun at 735 rpm to uniformly generate a 6 mm thick inner shell of refractory. After 30 mins of spinning, the mold assembly was stopped and allowed to air dry for 12 hours.

A propane/oxygen torch was used to preheat the mold inner refractory surface to 1315° C. The torch nozzle was positioned flush to the 100 mm opening in the end-cap and was directed into the mold and allowed to vent out the rear 100 mm opening in the opposing end-cap.

A transfer ladle, supported on a “Challenger 2” model 3360 weigh scale device, was used to measure 120 kg of silicon into the casting mold. Silicon metal was poured from the transfer ladle at 1520° C. into a refractory coated mold that was rotating at 735 rpm.

Mold speed was maintained at 735 rpm for 4 minutes to allow for impurity and slag separation. The mold speed was then slowly reduced to a point in which the material visually appeared as pooling in the bottom of the spinning mold and droplets appeared to be slumping at the top of the mold (near raining point). Mold speed was measured as 140 rpm and was maintained for 30 minutes with only ambient air cooling. The mold speed was then increased to 735 rpm and was maintained for 63 minutes of directional solidification. An alumina ceramic rod was inserted through the 100 mm opening in the mold cap to verify that the core of the casting was still liquid. The experiment was concluded when the casting was visually deemed solid and the dip rod was unable to penetrate the inner surface of the casting.

Experimental temperature data was recorded for the mold outside temperature using a Fluke 65 infrared thermometer measurement instrument. Internal mold, and ladle temperatures were measured using an Omega OS524 instrument. Mold rpm was measured using an Extech model TACH+IR instrument. Liquid silicon melt temperatures were measured using a HelectroNite model Heraeus instrument.

After 100% solidification, the casting was allowed to spin for an additional 45 minutes to provide air-cooling to the mold prior to removal from the centrifugal casting machine. The mold and casting were then removed and allowed to cool slowly overnight.

A hydraulic press was used to extract the casting from the steel mold body. The refractory shell was separated and the casting was blasted with silica grit to remove remaining traces of refractory.

The casting was sectioned, polished, and etched for visual inspection of crystal grain growth. The casting was core drilled and sliced into approximately 6 mm thick samples using a Buehler “Isomet 4000” sample slicer. Individual sample slice thicknesses were recorded along with the original total drilled core length. Saw kerf was calculated based on the comparison of total slice thickness relative to original drilled core length. Slice 01 was visually contaminated with a porous slag material and slice 12 contained visual refractory contamination from the casting to refractory interface.

Furnace and ladle melt samples were also submitted for analysis. Each sample slice was washed in a solution of 35% HCl mixed at a ratio of 1:4 with de-ionized water. Each sample slice was allowed to soak for 20 minutes in the solution before being rinsed in a container of 100% de-ionized water. After the water rinsing, each slice was then dipped into acetone to speed air drying of the sample.

Samples were ground in a Fritsch model “Pulverisette 0” mill and were analyzed using ICP-OEMs analysis. Specific boron and phosphorous data were tabulated into a spreadsheet, such that the slice closest to the refractory (casting O.D.), was indicated as the first data point. Volumetric % for each slice was calculated relative to the total casting volume through the summation of progressive slice and saw kerf thicknesses. Each slice was represented in the spreadsheet as a % of the total casting cylindrical volume.

Analytical data was compared against the theoretical expectations as a function of crystallization depth in Table 1 and FIGS. 3 and 4. The data contained in Table 1 demonstrates functional directional solidification verified through ICP-MS elemental analysis for boron (plotted against theoretical values in FIG. 3) and phosphorous (plotted against theoretical values in FIG. 4) for each sample slice. Results indicate at or near maximum theoretical value up to 82% yield (+/−10% analytical error). Slices #12 and #1 were omitted due to contamination from concentrated impurities and refractory.

TABLE 1

| | Cumulative | Cylin- | Scheil - | | | Phos- |
|---|---|---|---|---|---|---|
| | Volume | der | Eqn | Boron | Scheil - Eqn | phorous |
| Slice | cubic | Volume | Boron | Data | Phosphorous | Data |
| # | inches | % | ppmw | ppmw | ppmw | ppmw |
| 12 | 276.7 | 10 | 3.7 | 5.4 | 5.4 | 11.9 |
| 11 | 602.7 | 23 | 3.8 | 3.9 | 6.0 | 4.7 |
| 10 | 844.1 | 32 | 3.9 | 3.7 | 6.5 | 5.2 |
| 9 | 1106.7 | 41 | 4.0 | 3.5 | 7.2 | 5.1 |
| 8 | 1350.1 | 50 | 4.1 | 4 | 8.0 | 8.2 |
| 7 | 1570.9 | 59 | 4.3 | 4.8 | 9.0 | 8.2 |
| 6 | 1798.4 | 67 | 4.5 | 4 | 10.5 | 9.5 |
| 5 | 1991.5 | 74 | 4.7 | 4 | 12.3 | 10 |
| 4 | 2203.5 | 82 | 5.1 | 5.2 | 15.7 | 20.9 |
| 3 | 2386.0 | 89 | 5.6 | 7 | 21.5 | 49.6 |
| 2 | 2576.3 | 96 | 6.9 | 7.2 | 43.0 | 35.5 |
| 1 | 2676.1 | 100 | | 9.7 | | 21.9 |

ppmw = parts per million by weight

Example 1 illustrates some embodiments of the methods described herein. In particular, it illustrates the ability to perform the pouring and centrifugal casting of a silicon body within a centrifugal casting machine mold, as well as the ability to use torches to heat external and internal surfaces of the mold body. In addition, it demonstrates slippage and raining at a 3 G mold speed, and the ability to rapidly accelerate the mold and silicon to full speed (100 G) from at/near raining point (3 G). Moreover, it demonstrates pouring of molten silicon from the end-cap openings of the mold for demonstration of yield control, and the ability to perform purification of the silicon metal through directional solidification (Table 1) at 0.78 mm/min Finally, the example illustrates casting extraction and surface treatment.

### Example 2

Approximately 121 kg of silicon metal was melted in a 1000 lb “Box” InductoTherm induction furnace lined with an Engineered Ceramics “Hycor” model CP-2457 crucible and sealed with Vesuvius “Cercast 3000” top cap refractory. During the melting process, a nitrogen gas purge was introduced into the induction furnace headspace to reduce the formation of SiO gas and silicon dioxide.

The silicon melt was heated to 1532° C., prior to being poured into a Cercast 3000 refractory lined, transfer ladle. The transfer ladle was preheated to 995° C., using a propane/air fuel torch assembly. After pouring, the temperature of the silicon melt in the transfer ladle was measured at 1520° C. prior to pouring into the centrifugal casting machine. The silicon was sampled from both the furnace and transfer ladle to establish a baseline material elemental analysis.

A model M-24-22-12-WC centrifugal casting machine manufactured by the “Centrifugal Casting Machine Company” was fitted with a refractory lined, nominal 406 mm diameter×635 mm long steel casting mold. The silicon casting produced in this experiment measured 359 mm in diameter×635 mm long×71 mm wall thickness.

Advantage W5010 mold wash was sprayed onto the inner surface of the rotating casting mold to provide a base coating of approximately 1 mm thick. The steel mold was rotated at 58 rpm and was preheated to 175° C. using an external burner assembly. The mold was then sped up to 741 rpm and hand-loaded with a sufficient volume of Cercast 3000 refractory to centrifugally create a 19 mm thick refractory layer within the mold. The mold was then transferred to a heat treatment oven whereby the mold was maintained at 175° C. for an additional 4 hrs before being allowed to slowly cool to ambient temperature.

Vesuvius “Surebond SDM 35” was hand loaded into the mold cavity and the mold was spun at 741 rpm to uniformly generate a 6 mm thick inner shell of refractory. After 30 mins of spinning, the mold assembly was stopped and allowed to air dry for 12 hours.

A propane/oxygen torch was used to preheat the mold inner refractory surface to 1228° C. The torch nozzle was positioned flush to the 100 mm opening in the end-cap and was directed into the mold and allowed to vent out the rear 100 mm opening in the opposing end-cap.

Silicon metal was poured from the transfer ladle into the refractory coated mold which was spinning at 741 rpm. The transfer ladle was supported on a “Challenger 2” model 3360 weigh scale device and 120 kg of silicon was poured into the spinning mold. The mold was maintained at 741 rpm for 22 minutes to allow for impurity and slag separation and controlled directional solidification. The mold speed was then slowly reduced to zero and molten silicon poured from the end-cap openings of the mold cavity. At the end of the pouring step, the mold was rapidly accelerated to 741 rpm and 20 gpm of water spray cooling was provided to the outer surface of the mold until the casting was visibly dark in color.

Experimental temperature data was recorded for the mold outside temperature using a Fluke 65 infrared thermometer measurement instrument. Internal mold, and ladle temperatures were measured using an Omega OS524 instrument. Mold rpm was measured using an Extech model TACH+IR instrument. Liquid silicon melt temperatures were measured using a HelectroNite model Heraeus instrument.

The mold and casting assembly was then allowed to cool slowly overnight. A hydraulic press was used to extract the casting from the steel mold body. The refractory shell was separated and the casting was blasted with silica sand grit to remove remaining traces of refractory.

The casting was sectioned and the sections were polished, and etched for visual inspection of crystal grain growth. The casting was core drilled and sliced into approximately 6 mm thick samples using a Buehler “Isomet 4000” sample slicer. Individual sample slice thicknesses were recorded along with the original total drilled core length. Saw kerf was calculated based on the comparison of total slice thickness relative to original drilled core length.

Each sample slice was washed in a solution of 35% HCl mixed at a ratio of 1:4 with de-ionized water. Each sample slice was allowed to soak for 20 minutes in the solution before being rinsed in a container of 100% de-ionized water. After the water rinsing, each slice was then dipped into acetone to speed air drying of the sample. Each sample was then left on clean paper toweling to continue to air dry prior to the grinding step.

Furnace, ladle and casting samples were ground in a Fritsch model “Pulverisette 0” mill and were analyzed using ICP-OEMs analysis. Specific boron and phosphorous data was tabulated into a spreadsheet, relative to each slice number, such that the slice closest to the refractory (casting O.D.), was indicated as the first data point. Volumetric % for each slice was calculated relative to the total casting volume through the summation of progressive slice and saw kerf thicknesses. Each slice was represented in the spreadsheet as a % of the total casting cylindrical volume.

Analytical data was compared against the theoretical expectations as a function of crystallization depth in Table 2 and FIGS. 5 and 6. The analytical data contained in Table 2 demonstrates functional directional solidification verified through ICP-MS elemental analysis for boron (plotted against theoretical values in FIG. 5) and phosphorous (plotted against theoretical values in FIG. 6) for each sample slice. Results indicate at or near maximum theoretical value up to 82% yield (+/−10% analytical error). Slices #14 and #1 were omitted due to contamination from concentrated impurities and refractory.

TABLE 2

| | Cumulative | Cylin- | Scheil - | | | Phos- |
|---|---|---|---|---|---|---|
| | Volume | der | Eqn | Boron | Scheil - Eqn | phorous |
| Slice | cubic | Volume | Boron | Data | Phosphorous | Data |
| # | inches | % | ppmw | ppmw | ppmw | ppmw |
| 14 | 69.6 | 2.8 | 3.38 | 7.3 | 6.2 | 56.8 |
| 13 | 216.6 | 8.8 | 3.42 | 3.6 | 6.5 | 6.2 |
| 12 | 466.7 | 18.9 | 3.50 | 3.7 | 7.0 | 6.8 |
| 11 | 615.0 | 24.9 | 3.56 | 3.5 | 7.4 | 6.3 |
| 10 | 756.0 | 30.6 | 3.62 | 3.9 | 7.8 | 6.3 |
| 9 | 854.9 | 34.6 | 3.66 | 4.5 | 8.1 | 6.7 |
| 8 | 1004.1 | 40.7 | 3.73 | 4.2 | 8.6 | 8.5 |
| 7 | 1217.2 | 49.3 | 3.85 | 3.9 | 9.5 | 7.3 |
| 6 | 1446.1 | 58.6 | 4.01 | 3.8 | 10.9 | 9.1 |
| 5 | 1635.3 | 66.3 | 4.18 | 4.1 | 12.4 | 11.1 |
| 4 | 1863.8 | 75.5 | 4.45 | 4.6 | 15.3 | 14.8 |
| 3 | 2044.4 | 82.8 | 4.78 | 5.3 | 19.3 | 23.9 |
| 2 | 2240.0 | 90.8 | 5.41 | 8.5 | 28.8 | 103.5 |
| 1 | 2467.6 | 100.0 | | 10.4 | | 151.6 |

ppmw = parts per million by weight

Example 2 further illustrates some embodiments of the methods described herein. In particular, it illustrates the ability to practice the methods while operating at a constant high speed (100 G), and the use of recirculation currents generated within the rotating mold cavity to promote liquid mixing. It also demonstrates the ability to perform purification of the silicon metal through directional solidification (Table 2) at 1.3 mm/min, as well as concentration of impurities at the outer and inner diameter of the casting.

### Example 3

Approximately 107 kg, of silicon metal was melted in a 1000 lb “Box” InductoTherm induction furnace lined with an Engineered Ceramics “Hycor” model CP-2457 crucible and sealed with Vesuvius “Cercast 3000” top cap refractory. During the melting process, a nitrogen gas purge was introduced into the induction furnace headspace to reduce the formation of SiO gas and silicon dioxide.

The silicon melt was heated to 1520° C., prior to being poured into a Cercast 3000 refractory lined, transfer ladle. The transfer ladle was preheated to 800° C., using a propane/air fuel torch assembly. After pouring, the temperature of the silicon melt in the transfer ladle was measured at 1454° C. prior to pouring into the centrifugal casting machine. The silicon was sampled from both the furnace and transfer ladle to establish a baseline material elemental analysis.

A model M-24-22-12-WC centrifugal casting machine manufactured by the “Centrifugal Casting Machine Company” was fitted with a refractory lined, nominal 381 mm diameter×635 mm long steel casting mold. The silicon casting produced in this experiment measured 330 mm in diameter×635 mm long×96 mm wall thickness.

Advantage W5010 mold wash was sprayed onto the inner surface of the rotating casting mold to provide a base coating of approximately 1 mm thick. The steel mold was rotated at 58 rpm and was externally preheated to 175° C. using an external burner assembly. The mold was then sped up to 745 rpm and hand-loaded with a sufficient volume of Cercast 3000 refractory to centrifugally create a 19 mm thick refractory layer within the mold. The mold was then transferred to a heat treatment oven whereby the mold was maintained at 175° C. for an additional 4 hrs before being allowed to slowly cool to ambient temperature.

Vesuvius “Surebond SDM 35” was hand loaded into the mold cavity and the mold was spun at 745 rpm to uniformly create a 6 mm thick inner shell of refractory. After 30 min of spinning, the mold assembly was stopped and allowed to air dry for 12 hours.

A propane/oxygen torch was used to preheat the mold inner refractory surface to 1360° C. The torch nozzle was positioned flush to the 100 mm opening in the end-cap and was directed into the mold and allowed to vent out the rear 100 mm opening in the opposing end-cap.

Silicon metal was then poured from the transfer ladle into the refractory coated steel mold. Mold speed was recorded as 745 rpm. The transfer ladle was supported on a “Challenger 2” model 3360 weigh scale device and 106 kg's of silicon was poured into the spinning mold.

The mold was maintained at a constant speed of 745 rpm to allow for impurity and slag separation and for directional solidification of the complete casting. An alumina ceramic rod was inserted through the 100 mm opening in the mold cap to verify that the core of the casting was still liquid. At the end of 108 minutes, the experiment was concluded when the casting was visually deemed solid and the dip rod was unable to penetrate the inner surface of the casting.

At the point of 100% solidification, the casting was allowed to spin for an additional 45 minutes to provide air-cooling to the mold prior to removal from the centrifugal casting machine. The mold and casting were then removed and allowed to cool slowly overnight.

A hydraulic press was used to extract the casting from the steel mold body. The refractory shell was separated and the casting was blasted with silica sand grit to remove remaining traces of refractory.

Experimental temperature data was recorded for the mold outside temperature using a Fluke 65 infrared thermometer measurement instrument. Internal mold, and ladle temperatures were measured using an Omega OS524 instrument. Mold rpm's were measured using an Extech model TACH+IR instrument. Liquid silicon melt temperatures were measured using a HelectroNite model Heraeus instrument. A section of the casting was polished, and etched for visual inspection of crystal grain growth.

Example 3 further illustrates some embodiments of the methods described herein. In particular, it illustrates 100% solidification of casting, the ability to perform directional solidification at 0.88 mm/min, concentration of a 2.5 mm thick band of alumina-silicate mineral (mullite) impurity at the outer diameter of the casting, and concentration of 12 mm of slag at the inner diameter of the casting.

### Example 4

Approximately 108 kg, of silicon metal was melted in a 1000 lb “Box” InductoTherm induction furnace lined with an Engineered Ceramics “Hycor” model CP-2457 crucible and sealed with Vesuvius “Cercast 3000” top cap refractory. During the melting process, a nitrogen gas purge was introduced into the induction furnace headspace to reduce the formation of SiO gas and silicon dioxide.

The silicon melt was heated to 1524° C., prior to being poured into a Cercast 3000 refractory lined, transfer ladle. The transfer ladle was preheated to 800° C., using a propane/air fuel torch assembly. After pouring, the temperature of the silicon melt in the transfer ladle was measured at 1471° C. prior to pouring into the centrifugal casting machine. The silicon was sampled from both the furnace and transfer ladle to establish a baseline material elemental analysis.

A model M-24-22-12-WC centrifugal casting machine manufactured by the “Centrifugal Casting Machine Company” was fitted with a refractory lined, nominal 420 mm diameter×635 mm long steel casting mold. The silicon casting produced in this experiment measured 368 mm in diameter×635 mm long×56 mm wall thickness.

Advantage W5010 mold wash was sprayed onto the inner surface of the rotating casting mold to provide a base coating of approximately 1 mm thick. The steel mold was rotated at 58 rpm and was externally preheated to 175° C. using an external burner assembly. The mold was then sped up to 735 rpm and hand-loaded with a sufficient volume of Cercast 3000 refractory to centrifugally create a 19 mm thick refractory layer within the mold. The mold was then loaded into a heat treatment oven whereby the mold was maintained at 175° C. for an additional 4 hrs before being allowed to slowly cool to ambient temperature.

Vesuvius “Surebond SDM 35” was hand loaded into the mold cavity and the mold was spun at 735 rpm to uniformly create a 6 mm thick inner shell of refractory. After 30 min of spinning, the mold assembly was stopped and allowed to air dry for 12 hours.

A propane/oxygen torch was used to preheat the mold inner refractory surface to 1110° C. The torch nozzle was positioned flush to the 100 mm opening in the end-cap and was directed into the mold and allowed to vent out the rear 100 mm opening in the opposing end-cap.

A transfer ladle, supported on a “Challenger 2” model 3360 weigh scale device, was used to pour 106 kg's of silicon into a mold that was spinning at 735 rpm.

The mold was maintained at 735 rpm for 10 minutes to allow for impurity and slag separation. Mold speed was then slowly reduced to a point in which the material visually appeared as pooling in the bottom of the spinning mold and droplets appeared to be slumping at the top of the mold (near raining point). This speed was measured and recorded as 220 rpm. A propane/oxygen torch was positioned flush to the 100 mm opening in the end-cap and was directed into the mold and allowed to vent out the rear 100 mm opening in the opposing end-cap. At the end of 30 minutes, the torch was removed and the mold speed was reduced to zero to demonstrate pouring of molten silicon from the end-cap openings of the mold cavity.

Experimental temperature data was recorded for the mold outside temperature using a Fluke 65 infrared thermometer measurement instrument. Internal mold, and ladle temperatures were measured using an Omega OS524 instrument. Mold rpm's were measured using an Extech model TACH+IR instrument. Liquid silicon melt temperatures were measured using a HelectroNite model Heraeus instrument.

The mold and casting assembly was then allowed to cool slowly overnight A hydraulic press was used to extract the casting from the steel mold body. The refractory shell was separated and the casting was blasted with silica sand grit to remove remaining traces of refractory. The casting produced in this experiment varied in thickness from 2.5 to 7 mm Several samples were sectioned, polished, and etched for visual inspection of crystal grain growth.

Example 4 further illustrates some embodiments of the methods described herein. In particular, it illustrates the use of a propane/oxygen torch on the hollow body of the molten silicon to provide heat as a means to control the rate of directional solidification, slippage and raining at a mold speed at/near raining (10 G), and controlled directional solidification at 0.14 mm/min

Example 5

A total of 119kg of silicon metal was melted in a 1000 lb “Box” InductoTherm induction furnace lined with an Engineered Ceramics “Hycor” crucible and sealed with Vesuvius “Cercast 3000” top cap refractory. During the melting process, a nitrogen gas purge was introduced into the induction furnace headspace to reduce the formation of SiO gas and silicon dioxide.

The silicon melted in the 1000 lb furnace was heated to 1527° C. and was poured into a Cercast 3000 refractory lined, transfer ladle. The transfer ladle was preheated to approximately 1000° C., using a propane/air fuel torch assembly. The temperature of the silicon melt in the transfer ladle was measured at 1438° C. prior to pouring into the centrifugal casting machine. Molten silicon was sampled from both the furnace and the transfer ladle to establish a baseline material elemental analysis.

A model M-24-22-12-WC centrifugal casting machine manufactured by the “Centrifugal Casting Machine Company” was fitted with a refractory lined, nominal 400 mm diameter×635 mm long steel casting mold (inside dimensions). The silicon casting produced in this experiment measured 356 mm in diameter×635 mm long×78 mm wall thickness.

Advantage W5010 mold wash was sprayed onto the inner surface of the rotating casting mold to provide a base coating of approximately 0.5 mm thick. The steel mold was rotated at 58 rpm and was preheated to 175° C. using an external burner assembly. The mold was then sped up to 790 rpm and hand-loaded with a sufficient volume of Cercast 3000 refractory to centrifugally create a near 19 mm thick refractory layer within the mold. The mold was then transferred to a heat treatment oven whereby the mold was maintained at 175° C. for an additional 4 hrs before being allowed to slowly cool to ambient temperature.

Vesuvius “Triad FS” was hand loaded into the mold cavity and the mold was spun at 790 rpm to uniformly create a 3 mm thick inner shell of refractory. After 30 mins of spinning, the mold assembly was stopped and allowed to air dry for 12 hours.

While rotating at 150 rpm, a propane/oxygen torch was used to preheat the mold inner refractory surface to 1305° C. The torch nozzle was positioned flush to the 100 mm opening in the end-cap and was directed into the mold and allowed to vent out the rear 100 mm opening in the opposing end-cap.

Silicon metal was poured from the transfer ladle into the refractory coated mold which was spinning at 790 rpm. The transfer ladle was supported on a “Challenger 2” model 3360 weigh scale device and 119 kg of silicon was poured into the spinning mold. Two #15 “Victor” hydrogen/oxygen torches were installed flush to the inner mold cavity, and were balanced to provide oxidizing flames. Both torches were allowed to operate for 84 minutes before being removed from the process. The mold was maintained at 790 rpm for an additional 80 minutes to allow for 100% controlled directional solidification of the casting. The mold speed was then reduced to zero.

Experimental temperature data was recorded for the mold outside temperature using a Fluke 65 infrared thermometer measurement instrument. Internal mold, and ladle temperatures were measured using an Omega OS524 instrument. Mold rpm was measured using an Extech model TACH+IR instrument. Liquid silicon melt temperatures were measured using a HelectroNite model Heraeus instrument.

The mold and casting assembly was then allowed to cool slowly overnight. Both mold end-caps were then removed and the refractory was chipped away from the casting ends. A hydraulic press was used to press the silicon casting from the mold. Silica sand grit was then used to remove any remaining traces of refractory from the silicon surfaces.

The casting was sectioned, polished, and etched for visual inspection of crystal grain growth. The casting was then core drilled to form a 30 mm diameter cylinder which was then sliced into approximately 3-7 mm thick samples using a Buehler “Isomet 4000” sample slicer. Individual sample slice thicknesses were recorded along with the original total drilled core length. Saw kerf was calculated based on the comparison of total slice thickness relative to original drilled core length.

Each sample slice was washed in a solution of 35% HCl mixed at a ratio of 1:4 with de-ionized water. Each sample slice was allowed to soak for 20 minutes in the solution before being rinsed in a container of 100% de-ionized water. After the water rinsing, each slice was then dipped into acetone to speed air drying of the sample. Each sample was then left on a clean paper towel to continue to air dry prior to the grinding step.

Furnace, ladle and casting samples were ground in a Fritsch model “Pulverisette 0” mill and were analyzed using ICP-MS analysis. Specific boron and phosphorous data was tabulated into a spreadsheet, relative to each slice number, such that the slice closest to the refractory (casting O.D.), was indicated as the first data point. Volumetric % for each slice was calculated relative to the total casting volume through the summation of progressive slice and saw kerf thicknesses. Each slice was represented in the spreadsheet as a % of the total casting cylindrical volume.

Analytical data was compared against the theoretical expectations as a function of crystallization depth in Table 3 and FIGS. 7 and 8. The analytical data contained in Table 3 demonstrates functional directional solidification verified through ICP-MS elemental analysis for boron (plotted against theoretical values in FIG. 7) and phosphorous (plotted against theoretical values in FIG. 8) for each sample slice. Boron removal beyond the theoretical maximum as predicted by the Scheil equation is further demonstrated in Table 3 and FIG. 7 as a result of hydrogen/oxygen torch refinement. Results indicate at or beyond maximum theoretical value up to 84.5% yield (+/−10% analytical error). Slices #1 and #19 were omitted due to contamination from centrifugally concentrated impurities and refractory.

TABLE 3

| | Cumulative | Cylin- | Scheil - | | | Phos- |
|---|---|---|---|---|---|---|
| | Volume | der | Eqn | Boron | Scheil - Eqn | phorous |
| Slice | cubic | Volume | Boron | Data | Phosphorous | Data |
| # | inches | % | ppmw | ppmw | ppmw | ppmw |
| 1 | 169.6 | 6.5 | 4.5 | 3.7 | 5.6 | 5.3 |
| 2 | 290.1 | 11.1 | 4.5 | 4.0 | 5.7 | 5.5 |
| 3 | 429.3 | 16.4 | 4.6 | 4.2 | 6.0 | 6.7 |
| 4 | 559.7 | 21.4 | 4.6 | 4.4 | 6.2 | 6.9 |
| 5 | 691.5 | 26.4 | 4.7 | 4.2 | 6.5 | 8.1 |
| 6 | 804.0 | 30.7 | 4.7 | 4.8 | 6.8 | 8.0 |
| 7 | 920.2 | 35.2 | 4.8 | 4.8 | 7.1 | 8.8 |
| 8 | 1031.4 | 39.4 | 4.9 | 4.4 | 7.4 | 6.9 |
| 9 | 1149.6 | 43.9 | 4.9 | 4.5 | 7.7 | 7.9 |
| 10 | 1261.7 | 48.2 | 5.0 | 4.8 | 8.2 | 8.7 |
| 11 | 1389.0 | 53.1 | 5.1 | 4.4 | 8.7 | 8.5 |
| 12 | 1496.0 | 57.2 | 5.2 | 4.9 | 9.2 | 9.0 |
| 13 | 1599.6 | 61.1 | 5.3 | 4.7 | 9.8 | 9.1 |
| 14 | 1771.0 | 67.7 | 5.5 | 4.9 | 11.1 | 9.7 |
| 15 | 1941.9 | 74.2 | 5.8 | 5.2 | 12.8 | 11.1 |
| 16 | 2100.2 | 80.3 | 6.1 | 5.9 | 15.3 | 14.5 |
| 17 | 2211.0 | 84.5 | 6.4 | 6.0 | 17.9 | 15.9 |
| 18 | 2420.5 | 92.5 | 7.4 | 5.9 | 28.6 | 14.9 |
| 19 | 2616.8 | 100.0 | — | 5.2 | — | 9.0 |

ppmw = parts per million by weight

Example 5 further illustrates some embodiments of the methods described herein. In particular, it illustrates the ability to practice the methods in a 356 mm diameter casting while operating at a constant high speed (100 G), and the use of recirculation currents generated within the rotating mold cavity to promote liquid mixing. Example 5 also demonstrates the ability to perform purification of the silicon metal through directional solidification (Table 3) as well as the ability to perform additional boron removal using a hydrogen/oxygen torch directly combusted within the mold cavity/hollow silicon body.

### Example 6

A total of 122 kg of silicon metal was melted in a 1000 lb “Box”

InductoTherm induction furnace lined with an Engineered Ceramics “Hycor” crucible and sealed with Vesuvius “Cercast 3000” top cap refractory. During the melting process, a nitrogen gas purge was introduced into the induction furnace headspace to reduce the formation of SiO gas and silicon dioxide.

The silicon melted in the 1000 lb furnace was heated to 1523° C. and was poured into a Cercast 3000 refractory lined, transfer ladle. The transfer ladle was preheated to approximately 1000° C., using a propane/air fuel torch assembly. The temperature of the silicon melt in the transfer ladle was measured at 1433° C. prior to pouring into the centrifugal casting machine. Molten silicon was sampled from both the furnace and the transfer ladle to establish a baseline material elemental analysis.

A model M-24-22-12-WC centrifugal casting machine manufactured by the “Centrifugal Casting Machine Company” was fitted with a refractory lined, nominal 420 mm diameter×635 mm long steel casting mold (inside dimensions). The silicon casting produced in this experiment measured 375 mm in diameter×635 mm long×45 mm wall thickness.

Advantage W5010 mold wash was sprayed onto the inner surface of the rotating casting mold to provide a base coating of approximately 0.5 mm thick. The steel mold was rotated at 58 rpm and was preheated to 175° C. using an external burner assembly. The mold was then sped up to 753 rpm and hand-loaded with a sufficient volume of Cercast 3000 refractory to centrifugally create a near 19 mm thick refractory layer within the mold. The mold was then transferred to a heat treatment oven whereby the mold was maintained at 175° C. for an additional 4 hrs before being allowed to slowly cool to ambient temperature.

Vesuvius “Triad FS” was hand loaded into the mold cavity and the mold was spun at 753 rpm to uniformly create a 3 mm thick inner shell of refractory. After 30 mins of spinning, the mold assembly was stopped and allowed to air dry for 12 hours.

While rotating at 150 rpm, a propane/oxygen torch was used to preheat the mold inner refractory surface to 1316° C. The torch nozzle was positioned flush to the 100 mm opening in the end-cap and was directed into the mold and allowed to vent out the rear 100 mm opening in the opposing end-cap.

Silicon metal was poured from the transfer ladle into the refractory coated mold which was spinning at 753 rpm. The transfer ladle was supported on a “Challenger 2” model 3360 weigh scale device and 122 kg of silicon was poured into the spinning mold. The mold was maintained at 753 rpm for 56 minutes to allow for 60-70% controlled directional solidification of the casting. At the end of the directional solidification step, 2.3 kg of sodium silicate was added to the core of the spinning mold to act as a thermal barrier and a synthetic slag fluxing/pouring agent. Two minutes later, the mold speed was reduced to zero and the remaining silicon liquid and sodium silicate was poured from the end of the mold.

Experimental temperature data was recorded for the mold outside temperature using a Fluke 65 infrared thermometer measurement instrument. Internal mold, and ladle temperatures were measured using an Omega OS524 instrument. Mold rpm was measured using an Extech model TACH+IR instrument. Liquid silicon melt temperatures were measured using a HelectroNite model Heraeus instrument.

The mold and casting assembly was then allowed to cool slowly overnight. Both mold end-caps were then removed and the refractory was chipped away from the casting ends. A hydraulic press was used to press the silicon casting from the mold. Silica sand grit was then used to remove any remaining traces of refractory from the silicon surfaces.

The casting was sectioned, polished, and etched for visual inspection of crystal grain growth. The casting was then core drilled to form a 30 mm diameter cylinder which was then sliced into approximately 2-4 mm thick samples using a Buehler “Isomet 4000” sample slicer. Individual sample slice thicknesses were recorded along with the original total drilled core length. Saw kerf was calculated based on the comparison of total slice thickness relative to original drilled core length.

Each sample slice was washed in a solution of 35% HCl mixed at a ratio of 1:4 with de-ionized water. Each sample slice was allowed to soak for 20 minutes in the solution before being rinsed in a container of 100% de-ionized water. After the water rinsing, each slice was then dipped into acetone to speed air drying of the sample. Each sample was then left on a clean paper towel to continue to air dry prior to the grinding step.

Furnace, ladle and casting samples were ground in a Fritsch model “Pulverisette 0” mill and were analyzed using ICP-MS analysis. Specific phosphorous data was tabulated into a spreadsheet, relative to each slice number, such that the slice closest to the refractory (casting O.D.), was indicated as the first data point. Volumetric % for each slice was calculated relative to the total casting volume through the summation of progressive slice and saw kerf thicknesses. The casting cylindrical volume was calculated based on the mold cavity dimensions and the initial pour weight of silicon into the mold. Each slice was represented in the spreadsheet as a % of the calculated total casting cylindrical volume.

Analytical data was compared against the theoretical expectations as a function of crystallization depth in Table 4 and FIG. 9. The analytical data contained in Table 4 demonstrates functional directional solidification verified through ICP-MS elemental analysis for phosphorous (plotted against theoretical values in FIG. 9) for each sample slice. The analysis of the phosphorous elemental results indicates at/near theoretical segregation of impurities as compared to the Scheil equation (+/−10% analytical error). Slice #1 was omitted due to contamination from centrifugally concentrated impurities and refractory.

TABLE 4

| | Cumulative | | | |
|---|---|---|---|---|
| | Volume | Cylinder | Scheil - Eqn | Phosphorous |
| Slice | cubic | Volume | Phosphorous | Data |
| # | inches | % | ppmw | ppmw |
| 1 | 97.9 | 3.3 | 5.4 | 5.2 |
| 2 | 229.7 | 7.8 | 5.6 | 5.2 |
| 3 | 368.2 | 12.5 | 5.8 | 5.9 |
| 4 | 506.5 | 17.2 | 6.0 | 6.5 |
| 5 | 640.2 | 21.7 | 6.2 | 6.0 |
| 6 | 768.2 | 26.0 | 6.4 | 6.3 |
| 7 | 896.1 | 30.4 | 6.7 | 6.8 |
| 8 | 1022.6 | 34.6 | 7.0 | 6.5 |
| 9 | 1146.7 | 38.8 | 7.3 | 7.2 |
| 10 | 1270.3 | 43.0 | 7.6 | 8.0 |
| 11 | 1385.7 | 46.9 | 8.0 | 8.5 |
| 12 | 1485.7 | 50.3 | 8.3 | 7.9 |
| 13 | 1574.8 | 53.4 | 8.7 | 9.2 |
| 14 | 1723.7 | 58.4 | 9.3 | 10.3 |
| 15 | 1804.4 | 61.1 | 9.8 | 10.8 |

ppmw = parts per million by weight

Example 6 further illustrates some embodiments of the methods described herein. In particular, it illustrates the ability to practice the methods in a 375 mm diameter casting while operating at a constant high speed (100 G), and the use of recirculation currents generated within the rotating mold cavity to promote liquid mixing. Example 6 demonstrates partial solidification (61%), of the total casting and the ability to pour liquid silicon from the mold cavity. It also demonstrates the ability to perform purification of the silicon metal through directional solidification (Table 4) at 0.77 mm/min, as well as concentration of impurities at the outer surface of the casting. Example 6 further demonstrates the application of a synthetic slag for casting thermal control prior to pouring and the use of said slag to assist as a fluxing/pouring aid.

The present invention should not be considered limited to the specific examples described herein, but rather should be understood to cover all aspects of the invention. Various modifications and equivalent processes, as well as numerous structures and devices, to which the present invention may be applicable, will be readily apparent to those of skill in the art. Those skilled in the art will understand that various changes may be made without departing from the scope of the invention, which is not to be considered limited to what is described in the specification.

1. A method of refining silicon, comprising:
(I) providing a mold comprising a longitudinal axis, a mold cavity defined by an inner mold surface and a hollow bore extending along the longitudinal axis, and an outer mold surface;
(II) pre-heating the mold cavity;
(III) introducing a predetermined amount of molten silicon into the heated mold cavity while continuously rotating the mold around the longitudinal axis at a speed sufficient to form a hollow body of molten silicon comprising an inner surface and an outer surface that is in contact with the inner mold surface, wherein the body extends along the longitudinal axis of the mold; and
(IV) cooling the outer mold surface while continuously rotating the mold to effect directional solidification of the molten silicon from the outer surface of the body to the inner surface of the body.

2. The method according to claim 1, wherein the mold has a cylindrical shape and material of construction selected from steel, cast iron, steel alloy, molybdenum, titanium, and-ceramic, and any combination thereof

3. The method according to claim 2, wherein the mold has an orientation that is substantially horizontal or substantially vertical.

4. (canceled)

5. The method according to claim 1, wherein the inner mold surface comprises a high temperature, non-reactive refractory material selected from silica, silicon carbide, silicon nitride, boron nitride, alumina, magnesia, alumina-silicate, and any combination thereof.

6. (canceled)

7. (canceled)

8. The method according to claim 1, wherein the mold is rotated around the longitudinal axis at a speed sufficient to generate equivalent gravitational acceleration of from about 1 G to about 400 G in order to form the body of molten silicon.

9. The method according to claim 1, wherein directional solidification of the molten silicon occurs at a rate of from about 0.1 to about 3 millimeters/minute.

10. The method according to claim 1, further comprising refining the silicon by combusting a hydrogen/oxygen torch within the hollow body of molten silicon.

11. The method according to claim 1, further comprising rotating the heated mold after formation of the silicon body, wherein rotation occurs at a temperature and for a duration sufficient to cause one or more high density impurities in the molten silicon to concentrate near the outer surface of the body and one or more low density impurities to concentrate near the inner surface of the body.

12. The method according to claim 11, wherein at least one of the concentrated impurities is selected from aluminum, alumina, sodium, calcium, calcium oxide, iron , boron, phosphorus, silicon carbide, and any combination thereof; and, optionally, wherein at least one of the high density impurities concentrated near the outer surface of the body is silicon carbide.

13. (canceled)

14. (canceled)

15. The method according to claim 11, wherein the mold is rotated at a constant speed or at a plurality of speeds.

16. (canceled)

17. The method according to claim 1, further comprising rotating the heated mold after formation of the silicon body at a speed sufficient to cause slippage or raining of the molten silicon.

18. The method according to claim 17, wherein the rotational speed is sufficient to generate equivalent gravitational acceleration of from about 3 G to about 25 G; and, optionally, the method further comprising rapidly increasing the speed of the mold, wherein such speed is sufficient to generate equivalent gravitational acceleration of from about 140 G to about 300 G.

19. (canceled)

20. The method according to claim 17, wherein the rotational speed is sufficient to generate equivalent gravitational acceleration of from about 3 G to about 25 G; and, optionally, the method further comprising rapidly decreasing the speed of the mold, wherein such speed generates equivalent gravitational acceleration of from about 3 G to about 10 G.

21. The method according to claim 1, further comprising decreasing the speed of the mold to from about 0 to about 3 G and removing the molten silicon when from 50 to 80% (w/w) of the molten silicon has solidified after cooling of the outer mold surface.

22. The method according to claim 1, further comprising removing the molten silicon from the mold when less than 100% (w/w) of the molten silicon has solidified; wherein a hollow silicon casting remains within the mold, the casting comprising an inner surface and an outer surface that is in contact with the inner mold surface, the method optionally comprising separating the silicon casting from the mold and removing high and/or low density impurities from the outer surface and the inner surface of the silicon casting by surface treatment.

23. (canceled)

24. A method of refining silicon, comprising:
(I) providing a mold comprising a longitudinal axis, a mold cavity defined by an inner mold surface and a hollow bore extending along the longitudinal axis, and an outer mold surface;
(II) heating the mold cavity;
(III) introducing a predetermined amount of molten silicon into the heated mold cavity while
continuously rotating the mold around the longitudinal axis at a speed sufficient to form a hollow body of molten silicon comprising an inner surface and an outer surface that is in contact with the inner mold surface, wherein the body extends along the longitudinal axis of the mold;
(IV) refining the silicon by combusting a hydrogen/oxygen torch within the hollow body of molten silicon; and
(V) cooling the outer mold surface while continuously rotating the mold to effect directional solidification of the molten silicon from the outer surface of the body to the inner surface of the body.

25. The method according to claim 24, wherein the inner mold surface comprises a high temperature, non-reactive refractory material selected from silica, silicon carbide, silicon nitride, boron nitride, alumina, magnesia, alumina-silicate, and any combination thereof.

26. (canceled)

27. The method according to claim 24, wherein the mold is rotated around the longitudinal axis at a speed sufficient to generate equivalent gravitational acceleration of from about 1 G to about 400 G in order to form the body of molten silicon.

28. The method according to claim 24, further comprising rotating the heated mold after formation of the silicon body, wherein rotation occurs at a temperature and for a duration sufficient to cause one or more high density impurities in the molten silicon to concentrate near the outer surface of the body and one or more low density impurities to concentrate near the inner surface of the body.

29-32. (canceled)

33. A hollow body prepared according to the method of claim 1.
